(19) United States
(12) Patent Application Publication
(10) Pub. No.: US 2012/0084634 A1
(43) Pub. Date: Apr. 5, 2012

(54) METHOD AND APPARATUS FOR ANNOTATING TEXT

(75) Inventors: Ling Jun Wong, Escondido, CA (US); True Xiong, San Diego, CA (US)

(73) Assignee: SONY CORPORATION, Tokyo (JP)

(21) Appl. No.: 12/898,026

(22) Filed: Oct. 5, 2010

(51) Int. Cl. G06F 17/21

(52) U.S. Cl. 715/233

(57) ABSTRACT

Methods and apparatus are provided for annotating text displayed by an electronic reader application. In one embodiment a method includes detecting user selection of a graphical representation of text displayed by a device, displaying a window based on the user selection, the window including a selectable element for the user to annotate displayed text associated with the user selection. The method may further include detecting a user selection of a selectable element to record audio data based on the window, initiating audio recording based on the user selection to record audio data, and storing recorded audio data by the device as an annotation to the user selected text.

### FIELD

The present disclosure relates generally to electronic reading devices (e.g., eReaders), and more particularly to methods and apparatus for annotating digital publications.

### BACKGROUND

Typical electronic reading devices (e.g., eReaders) allow for users to view text. Some devices additionally allow users to mark portions of displayed text, such as an electronic bookmark. Digital bookmarks may be particularly useful for students to annotate textbooks and take notes. However, the conventional features for marking or annotating text is limited. Many devices limit the amount of text that may be added to a bookmark. Additionally, it may be difficult for users to enter annotations using an eReader during a presentation as many devices do not include a keyboard. Because eReaders typically allow for multiple texts to be stored and accessed by a single device, many users and students could benefit from improvements over conventional annotation features and functions. One drawback of typical eReader devices and computing devices in general may be capturing data of a presentation. Another drawback is the ability to correlate notes, or annotations to specific portions of electronic media. Accordingly, there is a desire for a solution that allows for improved annotation of digital publications.

### BRIEF SUMMARY OF THE EMBODIMENTS

Disclosed and claimed herein are methods and apparatus for annotating text displayed by an electronic reader application. In one embodiment, a method includes detecting user selection of a graphical representation of text displayed by a device, and displaying a window, by the device, based on the user selection, the window including a selectable element for the user to annotate displayed text associated with the user selection. The method further includes detecting a user selection of a selectable element to record audio data based on the window, initiating audio recording based on the user selection to record audio data, and storing recorded audio data by the device as an annotation to the user selected text.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a process for annotating text displayed by an eReader according to one embodiment;

FIG. 2 depicts a graphical representation of a device according to one or more embodiments;

FIG. 3 depicts a simplified block diagram of a device according to one embodiment;

FIG. 4 depicts a process for output of annotated data according to one or more embodiments;

FIGS. 5A-5B depict graphical representations of eReader devices according to one or more embodiments; and

FIG. 6 depicts a simplified system diagram for output of an access code according to one or more embodiments.

### DETAILED DESCRIPTION OF THE EXEMPLARY EMBODIMENTS

### Overview and Terminology

One embodiment relates to annotating text displayed by a device, such as an electronic reader (e.g., eReader) device, or a device executing an electronic reader application. For example, one embodiment is directed to a process for annotating text of an electronic book (e.g., eBook) and/or digital publication. In one embodiment, the process may include detecting a user selection of displayed text and a user selection to annotate at least a portion of the text. The process may further include displaying a window to allow a user to designate a particular annotation type for the displayed text. In one embodiment, the process may initiate recording of audio data to generate recorded audio data for an annotation. Recorded audio data for an annotation may be stored for future access by a user of the device. According to another embodiment, annotating data may be generated based on user input of text, selection of an image, and/or capture of image data. The process may similarly allow for annotation of one or more elements displayed by a device, such as an eReader, including image data.

In another embodiment, a device is provided that may be configured to generate one or more annotations based on user selection of a displayed digital publication, such as an eBook. The device may include a display and one or more control inputs for a user to select displayed data for annotation. The device may be configured to store annotation data for one or more digital publications and allow for a user to playback and/or access the annotation data. In certain embodiments, the eReader device may be configured to output annotation data, which may include transmission of annotation data to another device.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

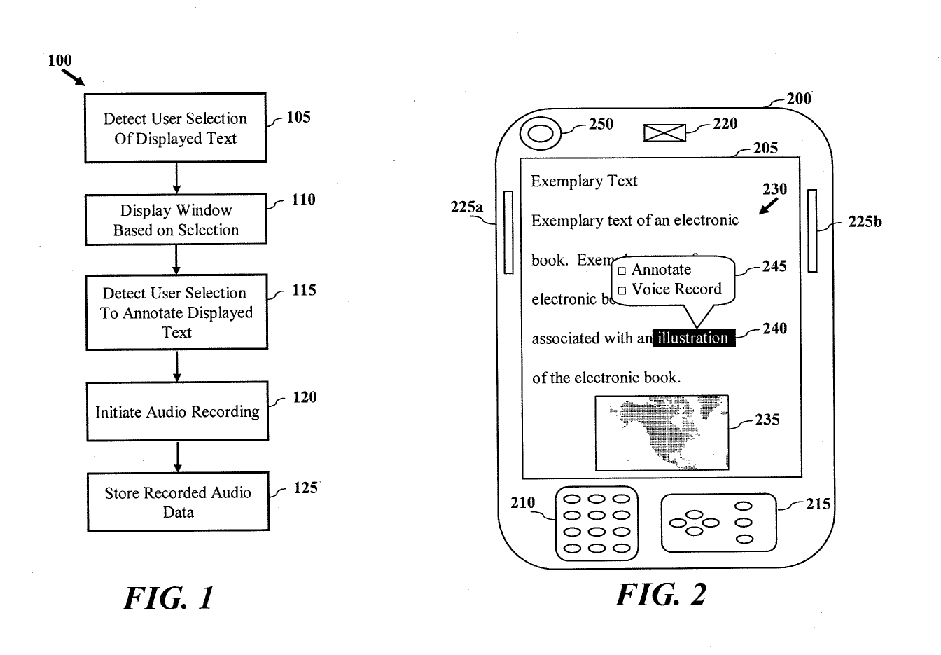

Referring now to the figures, FIG. 1 depicts a process for annotating text displayed by an electronic reader (e.g., eReader) application according to one or more embodiments. Process 100 may be employed by eReader devices and devices configured to provide eReader applications, such as computing devices, personal communication devices, media players, gaming systems, etc.

Process 100 may be initiated by detecting a user selection of a graphical representation of text displayed by a device at block 105. In one embodiment, the user selection may relate to one or more of highlighting and selecting the text. For example, when the eReader application is executed by an eReader device, or device in general, allowing for touch-screen commands, user touch commands to select text may be employed to highlight displayed text. Similarly, one or more controls of a device, such as a pointing device, track ball, etc., may be employed to select text.

At block 110, a window may be displayed by the device based on the user selection. The window may include one or more options available to the user associated with functionality of the eReader application. In one embodiment, the window may provide an option for the user to annotate displayed text associated with the user selection. Annotation of displayed text may relate to one or more of a text annotation, audio annotation, image data annotation and video imaging annotation. Annotation data may similarly include one or more of a date, time stamp and metadata in general. Annotation options may be displayed in the window based on one or more capabilities of a device executing the eReader application. The window may be displayed as one a pop-up window, or as a window pane, by a display of the device. A user selection to record audio data may be detected at block 115 based on a user selection of the window. Similarly to selection of text, selection of the window may be based on one or more controls of a device. For example, detecting the user selection to record audio data can relate to detecting one of a touch screen input and a control input of a device with the electronic reader application.

At block 120, audio recording may be initiated by the device based on the user selection to record audio data for an annotation. Audio recording may relate to recording voice data by a microphone of the device. Recorded audio data may then be stored at block 125 as an annotation to the text. For example, the audio data may be stored as file data of the media being displayed, or in a separate file that may be stored by the device and retrieved during playback of the particular eBook. One advantages of recording audio data for an annotation may include the ability to record annotation data for a live presentation, such as a lecture.

According to another embodiment, process 100 may further include displaying a text box for annotating the displayed text in addition to an audio recording annotation. A text box may be displayed by an eReader device similar to display of a window.

According to another embodiment, process 100 may further include one or more additional acts based on a stored annotation. By way of example, process 100 may include displaying a graphical element to identify an annotation associated with displayed text, such as an audio annotation or image annotation. It may be appreciated that a plurality of graphical elements may be employed to identify the type of annotation stored by a device. Process 100 may similarly include updating a graphical representation of text to identify an annotation associated with the text. For example, text may be displayed with one or more distinguishing attributes relative to other text displayed by the eReader. Process 100 may additionally include detecting a user selection of the updated version of text and outputting the audio recorded data. According to another embodiment, process 100 may further include transmitting recorded audio data to another device, such as another eReader device. Although, process 100 has been described above with reference to eReader devices, it should be appreciated that other devices may be configured to annotate electronic text and/or eBooks based on process 100.

Referring now to FIG. 2, a graphical representation is depicted of a device according to one or more embodiments. In one embodiment, device 200 may relate to an eReader device configured to display graphical representations of text associated with one or more of eBooks, electronic publications, and digital text in general. As user herein, “text” may include data relates to written text and may further include image data. According to another embodiment, device 200 may relate to an electronic device (e.g., computing device, personal communication device, media player, etc.) configured to execute an eReader application. In one embodiment, device 200 may be configured for annotating text associated with an eReader application.

As depicted in FIG. 2, device 200 includes display 205, keypad 210, control inputs 215, microphone 220 and speakers 225a-225b. Display 205 may be configured to display text shown as 230 associated with an eBook or digital text in general. Similarly, display 205 may be configured to display image data, depicted as 235, associated with an eBook or digital publication. In certain embodiments, image data 235 displayed by display 205 may relate to video data.

Keypad 210 relates to an alpha numeric keypad that may be employed to enter one or more characters and/or numerical values. In certain embodiments, device 200 may be configured to display a graphical representation of a keyboard for text entry. Keypad 210 may be employed to enter text for annotating an eBook and/or displayed publication. Control inputs 215 may be employed to control operation of device 200 including control of playback of an eBook and/or digital publication. In certain embodiment, control inputs may be employed to select displayed text and image data.

According to another embodiment, device 200 may optionally include imaging device 250 configured to capture image data including still images and video image data. In certain embodiments, image data captured by imaging device 250 may be used to annotate text of an eBook and/or digital publication.

According to one embodiment, device 200 may be configured to allow a user to annotate displayed text 230. It should also be appreciated that a user may similarly annotate displayed image data, such as image data 235. In one embodiment, device 200 may employ the process described above with reference to FIG. 2 to annotate displayed items. By way of example, a user may highlight text as depicted by 240. When display 205 relates to a touch screen device, user contact of text may result in highlighting a selected portion of text. In certain embodiments, control inputs 215 may be employed to selected displayed text and/or image data. Device 200 may be configured to display window 425 based on user selection of text. As depicted, window 245 includes one or more graphical elements may be selected by a user. For example, selection of voice record as displayed by window 245 may initiate audio recording for an annotation of selected text 240. Alternatively a user may selected a graphical element to annotate the text based by adding text, image data a network address and annotations in general.

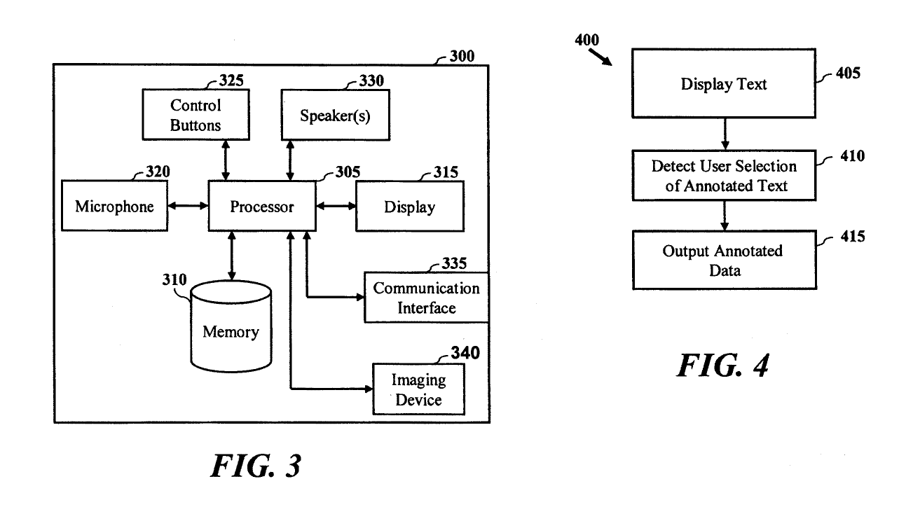

Referring now to FIG. 3, a simplified block diagram is depicted of a device according to one embodiment. In one embodiment, device 300 relates to the device of FIG. 2. Device 300 may relate to an eReader device configured to display graphical representations of text associated with one or more of eBooks, electronic publications, and digital text in general. As depicted in FIG. 3, device 300 includes processor 305, memory 310, display 315, microphone 320, control inputs 325, speaker 330, and communication interface 335. Processor 305 may be configured to control operation of device 300 based on one or more computer executable instructions stored in memory 310. In one embodiment, processor 305 may be configured to execute an eReader application. Memory 310 may relate to one of RAM and ROM memories and may be configured to store one or more files, and computer executable instructions for operation of device 300. In certain embodiments, processor 305 may be configured to convert text data to audio output.

Display 325 may be employed to display text, image and/or video data, and display one or more applications executed by processor 305. In certain embodiments, display 315 may relate to a touch screen display. Microphone 320 may be configured to record audio data, such as voice data.

Control inputs 325 may be employed to control operation of device 300 including controlling playback of an eBook and/or digital publication. Control inputs 325 may include one or more buttons for user input, such as a such as a numerical keypad, volume control, menu controls, pointing device, track ball, mode selection buttons, and playback functionality (e.g., play, stop, pause, forward, reverse, slow motion, etc). Buttons of control inputs 325 may include hard and soft buttons, wherein functionality of the soft buttons may be based on one or more applications running on device 300. Speakers 330 may be configured to output audio data.

Communication interface 335 may be configured to allow for transmitting annotated data to one or more devices via wired or wireless communication (e.g., Bluetooth™, infrared, etc.). Communication interface 335 may be configured to allow for one or more devices to communicate with device 300 via wired or wireless communication. Communication interface 335 may include one or more ports for receiving data, including ports for removable memory. Communication interface 335 may be configured to allow for network based communications including but not limited to LAN, WAN, Wi-Fi, etc. In one embodiment, communication interface 335 may be configured to access a collection stored by a server.

Device 300 may optionally include optional imaging device 340 configured to capture image data including still images and video image data. In certain embodiments, image data captured by imaging device 340 may be used to annotate text of an eBook and/or digital publication.

Referring now FIG. 4, a process is depicted for output of annotated data according to one or more embodiments. Process 400 may be employed by an eReader device, or device configured to execute an eReader application, to output one or more annotations. For example, output of annotation may relate to one or more of displaying a graphical representation of a textual annotation, displaying image data associated with an annotation, and transmitting annotation data. In one embodiment, process 400 may be initiated by displaying text at block 405. Displayed text may relate to one or more of an eBook and digital publication. Annotated text displayed by a device (e.g., device 200) at block 405 may be formatted to allow a user to identify one or more annotations.

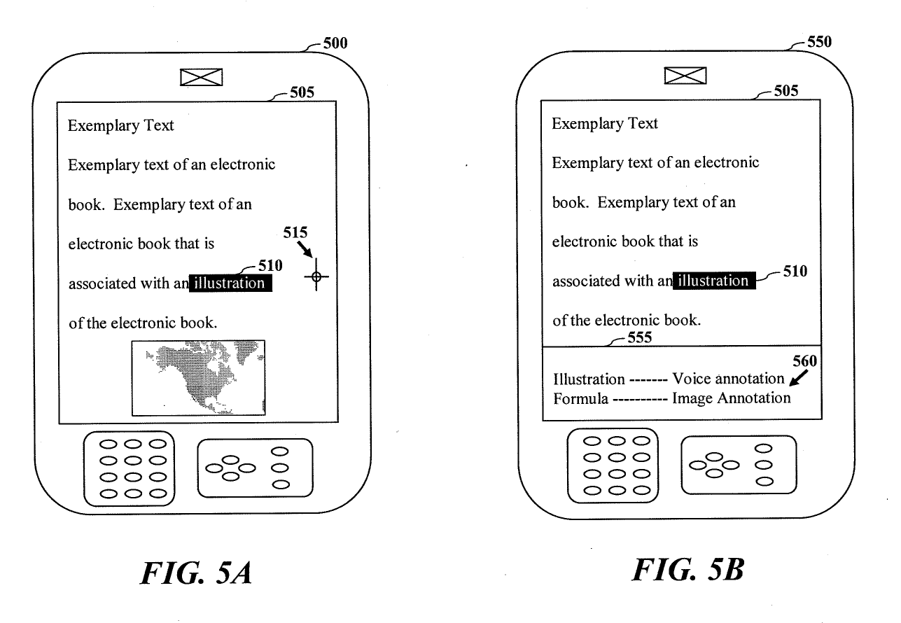

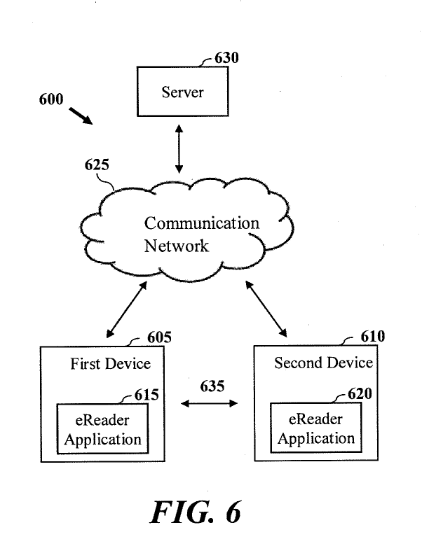

The device may be configured to detect a user selection of annotated text at block 410. Based on a user selection, the device may output annotated data at block 415. Output of annotated data may include display of annotated text. According to another embodiment, output of annotated data may relate to output of audio and/or video image data. In another embodiment, output of annotated data may relate to transmission of annotation data to another device. As will be discussed in more detail below with references to FIGS. 5A-5B and FIG. 6 output of annotated data may be performed using a device display or via transmission.

Referring now to FIGS. 5A-5B, graphical representations of eReader devices are depicted according to one or more embodiments. Referring first to FIG. 5A, eReader 500 is depicted including display 505. Annotated text is depicted as 510, wherein the text is displayed with highlighting. Based on a user annotation to highlighted text 510, device 500 may display graphical element 515 identifying annotation data associated with the highlighted text. Graphical element 515 may be displayed in a margin of the display panel. It may be appreciated that other types of graphical elements may be employed to indicate an annotation.

Referring now to FIG. 5B, a graphical representation is depicted of a eReader device according to another embodiment. eReader device 550 includes display 505 and highlighted text 510. Display 505 may include display of one or more annotations depicted as listing 555. Listing 555 may identification potions of text highlighted buy a user and further identify the type of annotation as depicted by 560. In certain embodiments, selection of an annotation as in listing 555 may result in an update of the display to display text associated with the annotation by display 505. In certain embodiments, a user may select an annotation from listing 555 for output of the annotation by device 550. In certain embodiments, eReader device 550 may be configured to allow a user to search within annotations. In another embodiment, graphical representations of annotations for a particular selection of text may be similarly applied to other instances of text.

Referring now to FIG. 6, a simplified system diagram is depicted for output of an access code according to one or more embodiments. According to one embodiment, annotation data may be transmitted by a device (e.g., device 200) via a communication network. As depicted, system 600 includes a first device 605, second device 610, communication network 625 and server 630. First device 605 and second device 610 may each be configured to execute an eReader application, depicted as 615 and 620, respectively. In one embodiment, annotation data stored by a device, such as first device 605, may be shared and/or transmitted based on network capability to communicate with a server, such as server 630 via communication network 620. Server 620 may be configured to store and transmit annotation data based on a user profile and/or association with a particular digital publication. In certain embodiments, annotation data may be transmitted based on a users request to transmit the data to a particular user. In other embodiments, annotation data may be uploaded to server 630 for access by one a user of second device 610 or other eReader devices.

According to another embodiment, annotation data stored by a device, such as first device 605, may be shared and/or transmitted directly to second device 610. In certain embodiments, eReader devices described herein may be configured for one or wired and wireless short range communication as depicted by 635. Transmission by first device 605 and second device 610 may relate to wireless transmissions (e.g., IR, RF, Bluetooth™). In one embodiment, first device 605 may be configured to initiate a transmission based on a user selection to transfer one or more annotations.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method for annotating text displayed by an electronic reader application, the method comprising the acts of:
detecting user selection of a graphical representation of text displayed by a device;
displaying a window, by the device, based on the user selection, the window including a selectable element for the user to annotate displayed text associated with the user selection;
detecting a user selection of a selectable element to record audio data based on the window;
initiating audio recording based on the user selection to record audio data; and
storing recorded audio data by the device as an annotation to the user selected text.

2. The method of claim 1, wherein the user selection of a graphical representation of text relates to at least one of highlighting and selecting the text.

3. The method of claim 1, wherein the window is displayed as one of a pop-up window and a window pane of a display.

4. The method of claim 1, wherein the user selection to record audio data relates to detecting one of a touch screen input and a button of a device with the electronic reader application.

5. The method of claim 1, wherein audio recording relates to voice recording by a microphone.

6. The method of claim 1, wherein storing the audio data relates to storing audio data in association with a file associated with displayed text.

7. The method of claim 1, wherein the device relates to one of a eReader device and a device executing an eReader application.

8. The method of claim 1, further comprising displaying a text box for annotating the displayed text in addition to the audio recording.

9. The method of claim 1, further comprising displaying a graphical element to identify annotated data associated with displayed text.

10. The method of claim 1, further comprising updating the graphical representation of text to identify annotated data associated with the text.

11. The method of claim 10, further comprising detecting a user selection of the annotated text and outputting the annotated data based on the user selection.

12. The method of claim 1, further comprising transmitting the recorded audio data to another device.

13. A computer program product stored on computer readable medium including computer executable code for annotating text displayed by an electronic reader application, the computer program product comprising:
computer readable code to detect user selection of a graphical representation of text displayed;
computer readable code to display a window based on the user selection, the window including a selectable element for the user to annotate displayed text associated with the user selection;
computer readable code to detect a user selection of a selectable element to record audio data based on the window;
computer readable code to initiate audio recording based on the user selection to record audio data; and
computer readable code to store recorded audio data as an annotation to the user selected text.

14. The computer program product of claim 13, wherein the user selection of a graphical representation of text relates to at least one of highlighting and selecting the text.

15. The computer program product of claim 13, wherein the window is displayed as one of a pop-up window and a window pane of a display.

16. The computer program product of claim 13, wherein the user selection to record audio data relates to detecting one of a touch screen input and a button of a device with the electronic reader application.

17. The computer program product of claim 13, wherein audio recording relates to voice recording by a microphone.

18. The computer program product of claim 13, wherein storing the audio data relates to storing audio data in association with a file associated with displayed text.

19. The computer program product of claim 13, wherein the device relates to one of a eReader device and a device executing an eReader application.

20. The computer program product of claim 13, further comprising further comprising computer readable code to display a text box for annotating the displayed text in addition to the audio recording.

21. The computer program product of claim 13, further comprising further comprising computer readable code to display a graphical element to identify annotated data associated with displayed text.

22. The computer program product of claim 13, further comprising further comprising computer readable code to update the graphical representation of text to identify annotated data associated with the text.

23. The computer program product of claim 22, further comprising further comprising computer readable code to detect a user selection of the annotated text and outputting the annotated data based on the user selection.

24. The computer program product of claim 13, further comprising further comprising computer readable code to transmit the recorded audio data to another device.

25. A device comprising:
a display; and
a processor coupled to the display, the processor configured to
detect a user selection of a graphical representation of displayed text;
control the display to display a window based on the user selection, the window including a selectable element for the user to annotate displayed text associated with the user selection;
detect a user selection of a selectable element to record audio data based on the window;
initiate audio recording based on the user selection to record audio data; and
control memory to store recorded audio data by the device as an annotation to the user selected text.

26. The device of claim 25, wherein the user selection of a graphical representation of text relates to at least one of highlighting and selecting the text.

27. The device of claim 25, wherein the window is displayed as one of a pop-up window and a window pane of a display.

28. The device of claim 25, wherein the user selection to record audio data relates to detecting one of a touch screen input and a button of a device with the electronic reader application.

29. The device of claim 25, wherein audio recording relates to voice recording by a microphone.

30. The device of claim 25, wherein storing the audio data relates to storing audio data in association with a file associated with displayed text.

31. The device of claim 25, wherein the device relates to one of a eReader device and a device executing an eReader application.

32. The device of claim 25, wherein the device is further configured to display a text box for annotating the displayed text in addition to the audio recording.

33. The device of claim 25, wherein the device is further configured to display a graphical element to identify annotated data associated with displayed text.

34. The device of claim 25, wherein the device is further configured to update the graphical representation of text to identify annotated data associated with the text.

35. The device of claim 34, wherein the device is further configured to detecting a user selection of the annotated text and outputting the annotated data based on the user selection.

36. The device of claim 25, wherein the device is further configured to transmit the recorded audio data to another device.
